(19) United States
(12) Patent Application Publication
(10) Pub. No.: US 2024/0289787 A1
(43) Pub. Date: Aug. 29, 2024

(54) METHODS AND SYSTEMS FOR DIGITAL ASSET VALIDATION USING A BLOCKCHAIN

(71) Applicant: United States Government as Represented by the Department of Veterans Affairs, Washington, DC (US)

(72) Inventors: Arpitha Parthasarathy, Washington, DC (US); Irma Molina, Washington, DC (US)

(21) Appl. No.: 18/583,346

(22) Filed: Feb. 21, 2024

Related U.S. Application Data
(60) Provisional application No. 63/486,781, filed on Feb. 24, 2023.

(51) Int. Cl. G06Q 20/38; G06Q 20/22

(52) U.S. Cl. CPC G06Q 20/389; G06Q 20/223

(57) ABSTRACT

Methods, systems, and apparatuses are described that are configured for an improved R&D process flow that involves peer-to-peer collaborations, linguistics services, peer review of manuscripts and the outcome of which will be stored as digitized medical/clinical library for developing public relations and marketing material for patient education and engagement using blockchain technology. A plurality of digital assets may be stored in a blockchain network. Each digital asset may be associated with a transaction. Each transaction may be associated with one or more peer nodes of a plurality of peer nodes in the blockchain network. The one or more digital assets may be sent based on one or more transactions satisfying a peer node threshold.

### CROSS REFERENCE TO RELATED PATENT APPLICATIONS

This application claims priority to U.S. Provisional Patent Application No. 63/486,781, filed on Feb. 24, 2023, which is hereby incorporated by reference in their entirety.

### BACKGROUND

Global research and research activities have progressed in recent years adding resources to public databases and knowledge. However, not all research activities are published, and thus, do not become accessible to the public. However, they may remain a knowledge source for the host institution that develops the data. Unfortunately, this leads to a scarcity of knowledge within the scientific community as a whole and the intended audiences for different groups of data. For example, many independent organizations and hospitals usually have their own internal research process and/or system, fail to receive adequate peer reviews, or lack the clinical and/or subject-based experts, or statistical reviewers, to testify and improve the quality of research. Universities and institutions tend to publish in their own scientific magazines due to funding restraints and/or frustration from failing to publish in peer-reviewed journals. Moreover, there are numerous studies from these universities and institutions that need the data management and clinical health science library management. Furthermore, many patient surveys and clinical health science library management tend to be recorded in different languages, and thus, may need one or more translations into the appropriate language for the intended audience before applying data analytics and interpreting the results for further peer reviews. In addition, health disparities persist among different demographic groups. Thus, a health burden is created due to a lack of linguistic and cultural adaptions because the research and development (R&D) discoveries remain unpublished and the flow of the clinical operation within the healthcare system gets destabilized and goes unnoticed by the patient. Linguistics in clinical medicine is a recently advancing field and there is a dearth of professionals who specialize in the gold standards such as the World Health Organization's guidelines for the process and translation adapting the ion of instruments and guidelines of good practice for the translation and cultural adaptation process (PROMs). Identifying peers in this field is required as a primordial for initiating the hospital's bench-to-bedside clinical operational process flow for the end user to be knowledgeable and aware to make use of the newer treatment modalities when the discoveries get published. To maximize the efficiency of handling several clinical projects through transparency, and interoperability with scientists, clinician peers, and graduate students, in conjunction with library sciences to enhance the hospital efficiency and output of every researcher, technological adaptations need to be established.

With increasing research and big data being published in scientific journals by universities and institutions, the nascent field of data management has gained more importance. For example, blockchain technology has been used as a public ledger to store several types of information. Although initially used for financial transactions, blockchain technology is increasingly being used to store other types of information such as products, packages, services, statuses, etc. However, the use of blockchain technology for healthcare adaptations is relatively new and lacks a systemic protocol for hospital-based R&D operations and in the clinical peer review process. The output of these peer review processes is required for generating a publication database for clinical library sciences. Since the entire peer review process using technological advancements is novel, a performance measure needs to be applied as a test of the hypothesis of the outcome to public relations strategies for audience engagement.

### SUMMARY

It is to be understood that both the following general description and the following detailed description are exemplary and explanatory only and is not restrictive. Methods, systems, and apparatuses for improved collaborations for outsourced peer manuscript review processes including analysis, clinical linguistics, and building a database for library services using blockchain technology are described. For example, a R&D Operations process flow my comprise: (1) collaboration for analytics, linguistics, and review of investigator-generated manuscripts by peers, which is a pre-journal submission requisite for one or more investigators of one or more backgrounds; (2) outsourcing to clinical linguistics professionals based on international standards; (3) a specific target population of patients of one or more backgrounds and/or medical and academic institutions that serve patients of one or more backgrounds; and (4) the use of technology systems, such as cloud and/or blockchain technologies, to maintain transparency and enable building a medical library to digitize and use the final output for marketing and public relations to promote knowledge expansion and in patient engagement.

In an embodiment, are methods comprising determining, by a computing device, a plurality of digital assets in a blockchain network, determining, based on each digital asset of the plurality of digital assets, a plurality of transactions, wherein each transaction of the plurality of transactions is associated with one or more peer nodes of a plurality of peer nodes in the blockchain network, determining, based on the one or more peer nodes associated with each transaction, a peer node threshold associated with each transaction, and sending, based on one or more transactions of the plurality of transactions satisfying the peer node threshold, one or more digital assets.

In an embodiment, is an apparatus comprising one or more processors, and a memory storing processor-executable instructions that, when executed by the one or more processors, cause the apparatus to determine, by a computing device, a plurality of digital assets in a blockchain network, determine, based on each digital asset of the plurality of digital assets, a plurality of transactions, wherein each transaction of the plurality of transactions is associated with one or more peer nodes of a plurality of peer nodes in the blockchain network, determine, based on the one or more peer nodes associated with each transaction, a peer node threshold associated with each transaction, and send, based on one or more transactions of the plurality of transactions satisfying the peer node threshold, one or more digital assets.

Additional advantages will be set forth in part in the description which follows or may be learned by practice. The advantages will be realized and attained by means of the elements and combinations particularly pointed out in the appended claims. It is to be understood that both the foregoing general description and the following detailed description are exemplary and explanatory only and are not restrictive.

### BRIEF DESCRIPTION OF THE DRAWINGS

To easily identify the discussion of any particular element or act, the most significant digit or digits in a reference number refer to the figure number in which that element is first introduced.

FIG. 1 shows an example computing system for implementing a cryptographically secured instrument in a distributed manner using one or more blockchains;

FIG. 2 shows an example implementation of a blockchain system;

FIG. 3 shows an example blockchain system for implementing a smart contract process;

FIG. 4 shows an example implementation of a R&D bench-to-bedside operational flow via a peer review process of publishing new clinical findings;

FIG. 5 shows a flowchart of an example peer review method using blockchain technology; and

FIG. 6 shows a block diagram of a computing device for implementing the example methods.

### DETAILED DESCRIPTION

Before the present methods and systems are disclosed and described, it is to be understood that the methods and systems are not limited to specific methods, specific components, or particular implementations. It is also to be understood that the terminology used herein is for the purpose of describing particular embodiments only and is not intended to be limiting.

As used in the specification and the appended claims, the singular forms “a,” “an” and “the” include plural referents unless the context clearly dictates otherwise. Ranges may be expressed herein as from “about” one particular value, and/or to “about” another particular value. When such a range is expressed, another embodiment includes—from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint and independently of the other endpoint.

“Optional” or “optionally” means that the subsequently described event or circumstance may or may not occur and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other components, integers or steps. “Exemplary” means “an example of” and is not intended to convey an indication of a preferred or ideal embodiment. “Such as” is not used in a restrictive sense, but for explanatory purposes.

“Hashes” (also referred to herein as “hash functions,” “cryptographic hash functions,” and the like) include functions that map an initial input data set to an output data set. The output from a hash function may be referred to herein as a “hash identifier,” “hash value,” “hash data set,” or simply, a “hash.” Generally, the output values from a given hash function have the same fixed length. Generally, if the same hash function is used on the same input data it will result in the same output data value. With some hash functions (including those used in the context of blockchain techniques and/or the subject matter of this application) the input value is computationally difficult to determine when only the output value is known. In certain examples, the input value for the hash function is supplemented with some additional random data. For example, an input value of “blockchain” for a hash function may include additional random data such as three random characters. Accordingly, the data value that is hashed may be “blockchaina7h” instead of simply “blockchain.” The additional random data is sometimes called a “nonce.”

Disclosed are components that can be used to perform the disclosed methods and systems. These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein, for all methods and systems. This applies to all aspects of this application including, but not limited to, steps in disclosed methods. Thus, if there are a variety of additional steps that can be performed it is understood that each of these additional steps can be performed with any specific embodiment or combination of embodiments of the disclosed methods.

The present methods and systems may be understood more readily by reference to the following detailed description of preferred embodiments and the examples included therein and to the Figures and their previous and following description.

As will be appreciated by one skilled in the art, the methods and systems may take the form of an entire hardware embodiment, an entire software embodiment, or an embodiment combining software and hardware aspects. Furthermore, the methods and systems may take the form of a computer program product on a computer-readable storage medium having computer-readable program instructions (e.g., computer software) embodied in the storage medium. More particularly, the present methods and systems may take the form of web-implemented computer software. Any suitable computer-readable storage medium may be utilized including hard disks, CD-ROMs, optical storage devices, magnetic storage devices, memristors, Non-Volatile Random Access Memory (NVRAM), flash memory, or a combination thereof.

Embodiments of the methods and systems are described below with reference to block diagrams and flowchart illustrations of methods, systems, apparatuses, and computer program products. It will be understood that each block of the block diagrams and flowchart illustrations, and combinations of blocks in the block diagrams and flowchart illustrations, respectively, can be implemented by computer program instructions. These computer program instructions may be loaded onto a general-purpose computer, special-purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

Accordingly, blocks of the block diagrams and flowchart illustrations support combinations of means for performing the specified functions, combinations of steps for performing the specified functions and program instruction means for performing the specified functions. It will also be understood that each block of the block diagrams and flowchart illustrations, and combinations of blocks in the block diagrams and flowchart illustrations, can be implemented by special purpose hardware-based computer systems that perform the specified functions or steps, or combinations of special purpose hardware and computer instructions.

Hereinafter, various embodiments of the present disclosure will be described with reference to the accompanying drawings.

Methods and systems are described for implementing a peer review process using blockchain technology. For example, a plurality of digital assets (e.g., research study projects) may be stored in a blockchain network. A plurality of transactions may be determined based on each digital asset of the plurality of digital assets. For example, each transaction may comprise a smart contract, wherein each contract may comprise data indicative of a peer review process associated with a digital asset. Each transaction may be associated with one or more peer nodes of a plurality of peer nodes in the blockchain network. In an example, the plurality of peer nodes may comprise one or more of a linguistics peer node, a data analytics peer node, a library sciences peer node, etc. For example, the peer review process may comprise one or more of a required number of reviews associated with one or more peer nodes or one or more required reviews associated with one or more peer nodes associated with one or more characteristics. One or more characteristics may comprise one or more of an academic level of a peer node or a background of a peer node. For example, the peer review process may comprise one or more levels of review of the digital asset, wherein one or more levels of review are associated with one or more parameters. One or more parameters may comprise one or more of the required number of reviews by one or more peer nodes of one or more backgrounds or a review by a required peer node. Each transaction may be stored in a blockchain ledger of the blockchain network according to a transaction number and a block number identifying the location of the transaction in the blockchain ledger. Each transaction may be associated with one or more peer nodes of a plurality of peer nodes in the blockchain network. A peer node threshold associated with each transaction may be determined based on the one or more peer nodes associated with each transaction. One or more digital assets may be sent based on one or more transactions of the plurality of transactions satisfying the peer node threshold. For example, one or more digital assets may be sent to a device associated with a device library.

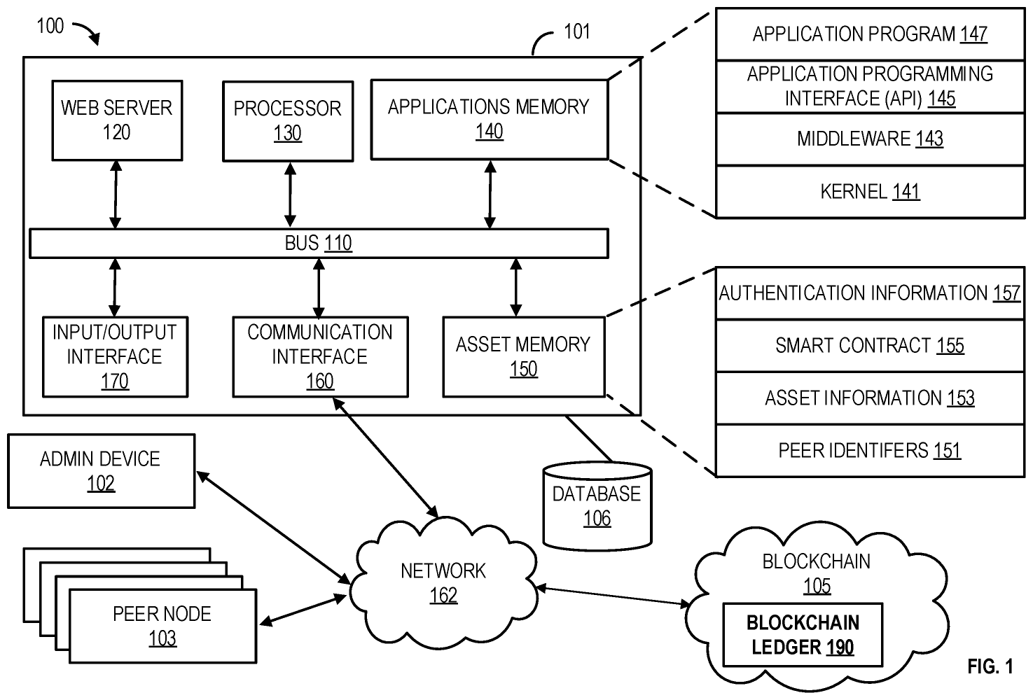

FIG. 1 shows an example computing system 100 including a server computing device 101 for implementing the cryptographically secured instrument system in a distributed manner using one or more blockchains for performing applications utilizing one or more transactions associated with one or more peer nodes of a plurality of peer nodes associated with a plurality of digital assets, according to various embodiments. The server computing device 101 may include a bus 110, a web server 120, a processor 130, an application memory 140, an asset memory 150, a communication interface 160, and an input/output interface 170. For example, the server computing device 101 may omit at least one of the aforementioned constitutional elements or may additionally include other constitutional elements. For example, server computing device 101 may include a plurality of servers.

System 100 may further include a blockchain system 105 for storing one or more blockchain ledgers related to one or more digital assets (e.g., research study projects), a server computing system 101 for performing operations utilizing one or more blockchain ledgers, and one or more user devices (e.g., peer nodes 103) for accessing services provided by the server computing system 101. The blockchain system 105, server computing device 101, and peer nodes 103 may be interconnected via network 162. System 100 may also include one or more databases 106 providing access to various data and/or processing by third-party systems. Database 106 may be connected to the server computing system 101 directly or indirectly via network 162.

The bus 110 may include a circuit for connecting the web server 120, the processor 130, the applications memory 140, the asset memory 150, the communication interface 160, and the input/output interface 170 to each other and for delivering communication (e.g., a control message and/or data) between the web server 120, the processor 130, the applications memory 140, the asset memory 150, the communication interface 160, and the input/output interface 170.

The web server 120 may include one or more web servers and/or other servers, such as but not limited to, application servers, load balancing servers, etc., and operates to receive inputs from operators including administrators and users of the server computing device 101. The web server 120, in response to inputs received from an operator or in response to internally generated signals, may perform or cause the server computer device 101 to perform operations for maintaining records of asset ownership, transactions (e.g., smart contracts), or peer reviews in an immutable manner using a blockchain, and/or for providing services utilizing immutable records of asset ownership in a blockchain.

The processor 130 may include one or more of a Central Processing Unit (CPU), an Application Processor (AP), and a Communication Processor (CP). The processor 130 may control, for example, at least one of the web servers 120, the applications memory 140, the asset memory 150, the communication interface 160, and the input/output interface 170 and/or may execute an arithmetic operation or data processing for communication. The processing (or controlling) operation of processor 130 according to various embodiments is described in detail with reference to the following drawings.

The application's memory 140 may include a volatile and/or non-volatile memory. The applications memory 140 may store, for example, a command or data related to at least one different constitutional element of the server computing device 101. According to various exemplary embodiments, the applications memory 130 may store software and/or a program 140. The program 140 may include, for example, a kernel 141, a middleware 143, an Application Programming Interface (API) 145, and/or an application program (or an “application”) 147, or the like, configured for controlling one or more functions of the server computing device 101 and/or an external device. At least one part of the kernel 141, middleware 143, or API 145 may be referred to as an Operating System (OS). The application's memory 140 may include a computer-readable recording medium having a program recorded therein to perform the method according to various embodiments by the processor 130.

The kernel 141 may control or manage, for example, system resources (e.g., the bus 110, the processor 130, the applications memory 140, etc.) used to execute an operation or function implemented in other programs (e.g., the middleware 143, the API 145, or the application program 147). Further, the kernel 141 may provide an interface capable of controlling or managing the system resources by accessing individual constitutional elements of the electronic device 101 in the middleware 143, the API 145, or the application program 147.

The middleware 143 may perform, for example, a mediation role so that the API 145 or the application program 147 can communicate with kernel 141 to exchange data.

Further, the middleware 143 may handle one or more task requests received from the application program 147 according to a priority. For example, middleware 143 may assign a priority of using the system resources (e.g., the bus 110, the processor 130, or the applications memory 140) of the server computing system 101 to at least one of the application programs 147. For instance, the middleware 143 may process one or more task requests according to the priority assigned to at least one of the application programs, and thus may perform scheduling or load balancing on one or more task requests.

The API 145 may include at least one interface or function (e.g., instruction), for example, for file control, window control, video processing, or character control, as an interface capable of controlling a function provided by the application 147 in the kernel 141 or the middleware 143.

The server computing device 101 may further include asset memory 150. Asset memory 150 may include peer identifier information 151 and, optionally, one or more other storage memories including asset information 153, smart contract information 155, and authentication information 157.

Similar to the applications memory 140, the asset memory 150 may include a volatile and/or non-volatile memory. For example, the asset memory 150 may include data structures or other logical structures used to store associated data on one or more common or dedicated electronic data storage (e.g., RAM, FLASH memory, or a hard drive). For example, dedicated hardware devices, such as a hardware security module (HSM), may be used to store information associated with the asset memory 150. In an example, the asset memory 150 may be stored on a dedicated storage hardware externally provided and in communication with the server computing device 101, including the database 106. In an example, the asset memory 150 may be included within the same memory unit/device as the applications memory 140.

The peer identifier information 151 may comprise identifier information associated with one or more individuals that may be required to perform one or more peer reviews for one or more digital assets (e.g., research study projects) based on one or more transactions (e.g., smart contracts). For example, the peer identifier information 151 may comprise data indicative of an identifier associated with each peer node 103. For example, each identifier may comprise an address, or unique identifier, configured for enabling a peer node 103 access to the digital asset. For example, a smart contract may identify a peer review process associated with a digital asset. The smart contract may comprise data that indicates identifiers of one or more of the peer nodes 103 required for a peer review process associated with a digital asset. The peer nodes 103 associated with the identifiers designated in the smart contract may be provided access to the designated digital asset in order to perform a peer review of the digital asset.

Asset information memory 153 may comprise identifying information associated with the digital assets stored in the blockchain system 105. For example, asset information memory 153 may store the name of each digital asset (e.g., research study project), author information of each digital asset, the status of each digital asset, etc., for which the asset information may be recorded in the blockchain.

Smart contract information 155 may comprise data indicative of a peer review process associated with each digital asset. For example, the smart contract information 155 may comprise data indicative of one or more of the required number of reviews associated with one or more peer nodes 103 for a digital asset or one or more required reviews associated with the one or more peer nodes 103 associated with one or more characteristics for a digital asset. The one or more characteristics may comprise one or more of an academic level of a peer node 103 or a background of a peer node 103. For example, the smart contract information 155 may comprise one or more levels of review of the digital asset, wherein the one or more levels of review are associated with one or more parameters. The one or more parameters may comprise one or more of the required number of reviews by one or more peer nodes 103 of one or more backgrounds or a review by a required peer node 103. In an example, the smart contract may comprise data that indicates identifiers of one or more of the peer nodes 103 required for a peer review process associated with a digital asset.

Authentication information 157 may comprise information for authenticating the users (e.g., peer nodes 103, administrative personnel, etc.) of the system. The users (e.g., peer nodes 103) of the system may comprise individuals that may be part of one or more review processes associated with one or more digital assets recorded in memories 153 and/or 155, proxies for the individuals, etc.

The communication interface 160 may establish, for example, communication between the server computing device 101 and the external devices (e.g., admin device 102, peer nodes 103, blockchain 105, etc.). For example, the communication interface 160 may communicate with the external device (e.g., admin device 102, peer nodes 103, blockchain 105, etc.) by being connected to network 162 through wireless communication or wired communication. For example, as a cellular communication protocol, wireless communication may use at least one of Long-Term Evolution (LTE), LTE Advance (LTE-A), Code Division Multiple Access (CDMA), Wideband CDMA (WCDMA), Universal Mobile Telecommunications System (UMTS), Wireless Broadband (WiBro), Global System for Mobile Communications (GSM), and the like. The wired communication may include, for example, at least one Universal Serial Bus (USB), High-Definition Multimedia Interface (HDMI), Recommended Standard-232 (RS-232), power-line communication, Plain Old Telephone Service (POTS), and the like. Network 162 may include, for example, at least one of a telecommunication network, a computer network (e.g., LAN or WAN), the internet, and a telephone network.

The input/output interface 170 may comprise an interface for delivering an instruction or data input from a user or a different external device(s) to the different constitutional elements of the server computing device 101. The input/output interface 170 may output an instruction or data received from the different constitutional clement(s) of the server computing device 101 to the different external devices. For example, the input/output interface 170 may be a web-based interface that enables an administrator or other operator to access information stored on the blockchain and/or to store information on the blockchain. The input/output interface 170 may include a client-based part that may execute on the access device (e.g., admin device 102 or peer nodes 103) being used by an administrator or other operator, and a server part that may be performed by the web server 120. The input/output interface 170 may include a web-based or app-based graphical user interface (GUI) for creating and managing accounts, administering/adjusting peer review requirements, etc.

For example, server computing device 101 may comprise a group of one or more servers. For example, all or some of the operations executed by the server computing device 101 may be executed in a different one or a plurality of electronic devices (e.g., the admin device 102 or the peer nodes 103). For example, if the server computing device 101 needs to perform a certain function or service either automatically or based on a request, the server computing device 101 may request at least some parts of functions related thereto alternatively or additionally to a different electronic device (e.g., the admin device 102 or the user device 103) instead of executing the function or the service autonomously. The different electronic devices (e.g., the admin device 102 or the user device 103) may execute the requested function or additional function and may deliver a result thereof to the server computing device 101. The server computing device 101 may provide the requested function or service either directly or by additionally processing the received result. For this, for example, a cloud computing, distributed computing, or client-server computing technique may be used.

In an example, the server computing device 101 may be configured to determine a plurality of digital assets in a blockchain network (e.g., blockchain network 105). For example, each digital asset of the plurality of digital assets may comprise a research study project. A plurality of transactions may be determined based on each digital asset of the plurality of digital assets. Each transaction of the plurality of transactions may be associated with one or more peer nodes 103 of a plurality of peer nodes 103 in the blockchain network 105. For example, each transaction may be stored in a blockchain ledger of the blockchain network according to a transaction number and a block number identifying the location of the transaction in the blockchain ledger. Each transaction may comprise a smart contract comprising data indicative of a review process associated with a digital asset. A peer node threshold associated with each transaction may be determined based on one or more peer nodes 103 associated with each transaction. For example, the peer node threshold may be determined based on a review process associated with each transaction. For an example, a plurality of blockchain indexes may be generated based on the peer review process associated with each digital asset. For example, each blockchain index of the plurality of blockchain indexes may be associated with each digital asset. In an example, each blockchain index of the plurality of blockchain indexes may be updated based on one or more reviews by the one or more peer nodes 103 associated with each transaction. For example, each blockchain index may be updated based on the completion of each level of review associated with each review process of each digital asset. One or more digital assets may be sent based on one or more transactions of the plurality of transactions satisfying the peer node threshold. For example, one or more digital assets may be sent to a device associated with a digital library.

The admin device 102 and the peer nodes 103 may be used to access the services of the server computing device 102. For example, the admin device 102 may be configured to create/determine a transaction (e.g., smart contract or peer review process that can involve a collaboration, review of the manuscript, analysis, medical linguistics services, etc.) for each digital asset. In an example, the peer node 103 may be configured to generate/create peer reviews associated with each transaction associated with each digital asset. For example, the peer nodes 103 may comprise one or more of a linguistics peer node, a data analytics peer node, a library sciences, etc. The admin device 102 and the peer nodes 103 may comprise networked computing devices for accessing the services of the server computing device 102. For example, the computing devices may comprise one or more of a smartphone, tablet, laptop computer, desktop computer, or other computing devices.

The blockchain system 105 may comprise one or more processors for processing commands and one or more memories for storing information in one or more blockchain data structures. The blockchain system 105 may be publically assessable (e.g., a distributed decentralized computing system) or may be privately run by a third-party entity or the same entity that is running the server computing device 101. The blockchain system 105 maintains one or more blockchains, or distributed blockchain ledgers 190, of continuously growing lists of data blocks, where each data block refers to previous blocks on its lists. The requirement for each block to refer to all previous blocks in the blockchain yields a chain of blocks that is hardened against tampering and revision, such that the information stored in the blockchain is immutable. That is, the work required to successfully tamper with or change data in even one block on the blockchain while still maintaining the validity of the blockchain would impose a cost in computing power and time so prohibitively high, that it is not practically possible for even an administrator of the blockchain system 105 to successfully tamper with or change transaction data already in the blockchain.

Transactions represent the content (e.g., smart contracts) to be stored in the blockchain. Blocks of transactions record and confirm when and in what sequence transactions enter and are logged in the blockchain. For example, block indexes may be generated based on the review processes associated with each digital asset. The block indexes may be updated based on one or more reviews by the one or more peer nodes 103 associated with each transaction. The blocks may be generated or created, from transactions associated with the one or more peer nodes 103. Once a new block is generated that includes a submitted transaction, that transaction becomes a part of the blockchain. The blockchain is then distributed to the various computing nodes that make up the blockchain system.

The server computer device 101 may include or may connect over a network to, the database 106. Database 106 may include one database or multiple databases at one or more locations and may store account information, audit information, mappings between blockchain transactions, and a means of encoding metadata defining aspects of digital assets to be recorded in the blockchain and other data. For example, database 106 may include one or more external databases or data services. For example, database 106 may include a data service provided by an entity different from the entity controlling the server computing system 101, such as but not limited to, external data services providing digital asset information, author information associated with each digital asset, the status of each digital asset (e.g., peer review status), the user or peer node authentication information, etc.

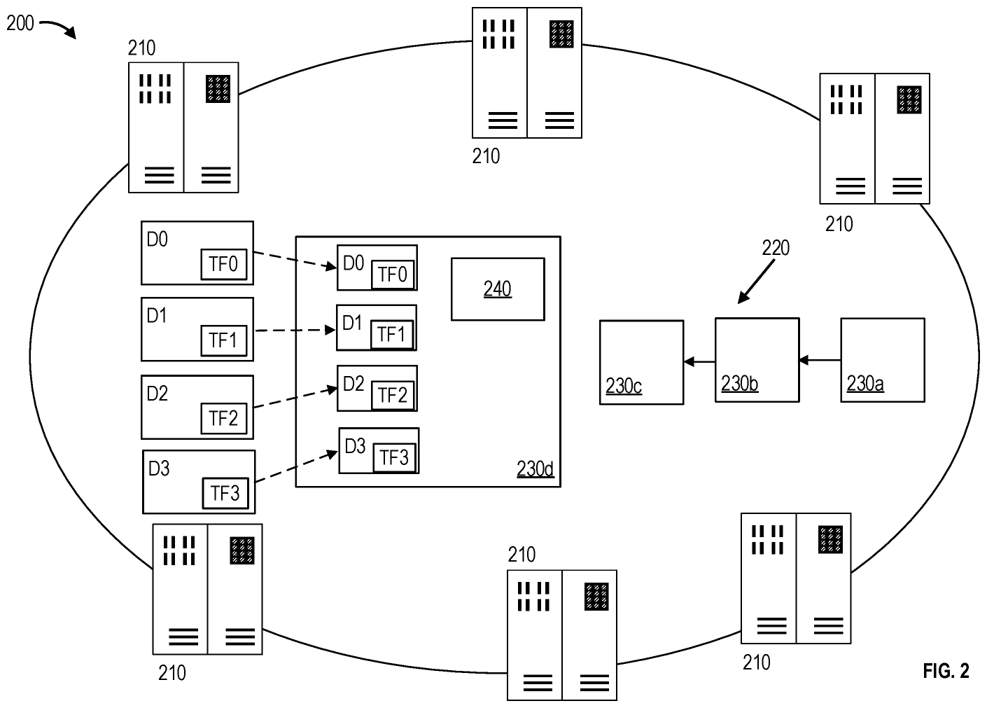

FIG. 2 illustrates an example of blockchain system 105. The blockchain system 105 may comprise a network of 200 of nodes 210. Each node 210 may comprise a computing device, a central processing unit, a graphical processing unit, a field programmable gate array, or an application specific integrated circuit. In an example, each node 210 may comprise a content distribution device, such as a cable modem, set-top box, laptop, smart phone, tablet, wearable computing device, mobile computing device, or any computing device in communication with a content distribution network.

The network 200 of nodes 210 may comprise a decentralized database. The decentralized database may not have a central administrator or centralized storage. For example, each node 210 in network 200 may store a copy of a collection of data, such as a distributed ledger. A distributed ledger may comprise a list of recorded entries, such as transactions (e.g., smart contracts). The data may be replicated, shared, or synchronized across the nodes 210. The decentralized database may be continually reconciled, such as to reflect changes to the collection of data. Nodes 210 may continually or periodically download the most recent version of the collection of data. When node 210 joins network 200, node 210 may automatically download the collection of data.

A decentralized database, such as a distributed ledger, may comprise a blockchain 220. The decentralized database, such as the distributed ledger, may comprise a blockchain database and/or utilize blockchain data management techniques. A blockchain 220 may comprise one or more blocks 230 in which data is recorded. For example, the digital assets (e.g., research study projects) and/or the transactions (e.g., smart contracts) may be stored in one or more blocks 230. Blocks 230 in blockchain 220 may function as a mechanism to organize the data (e.g., digital assets and/or transactions) in blockchain 220. For example, the block 230 may be linked in a sequence determined by a relationship of the data in block 230, such as the chronology in which the data is recorded or validated. For example, the digital assets (e.g., research study projects) stored in block 230 may be recorded and/or validated according to the transactions (e.g., smart contracts). Blocks 230 may be linked to deter retroactive modification of data in blockchain 220.

The nodes 210 in network 200 may build blockchain 220, such as by adding blocks 230 to blockchain 220. The nodes 210 may perform several operations to build blockchain 220. For example, when new data D0, D1, D2, and D3 are received by network 200, node 210 may validate the new data D0, D1, D2, and D3. As an example, if the new data D0, D1, D2, and D3 comprises transactions, node 210 may validate, verify, or authenticate the identity of the parties (e.g., peer nodes) to the transaction. A transaction may further include a public key of a party (e.g., peer nodes) to the transaction and a digital signature of the party (e.g., peer nodes) to the transaction. The digital signature may comprise the hash of transaction data, such as with a cryptographic hash function. The digital signature may comprise a hash of transaction data encrypted with a private key corresponding to the public key. Examples of hash functions include MD4, MD5, SHA-1, SHA-256, SHA-512, and SHA-3. The digital signature may be validated by the node 210, such as by decrypting the digital signature with the public key. The digital signature may allow for verification of the transaction (e.g., smart contract completion/validation) while maintaining the anonymity of the parties to the transaction. For example, the digital signature may allow for verification of a review by a peer node, wherein the review is associated with a requirement of a transaction, or smart contract, associated with a digital asset (e.g., research study project). In an example, each peer node may comprise one or more of a linguistics peer node, a data analytics peer node, a library sciences peer node, etc.

The nodes 210 may collate the new data D0, D1, D2, and D3 into a new block 230d. Node 210 may record one data entry D0 in a new block 230d. Node 210 may perform an operation to add the new block 230d to the blockchain 220. For example, if the data in blocks 230 is related chronologically, such as where the first block 230a in the blockchain records older data than the data of subsequent blocks 230b, 230c, the nodes 210 may perform a timestamp function to log the sequence in which blocks 230 are added to the blockchain 220. The nodes 210 may append a hash of the previous block 230c to the new block 230d. Node 210 may insert an output of the previous block 230 in an input of the new block 230d. The chaining of the blocks, such as through iterative functions, may deter retroactive modification of data in block 230 as the modification would require new functions to be performed for all of the subsequent blocks 230 in the blockchain 220. For example, the chaining of the blocks may prevent tampering with the peer review processes of the digital assets by unauthorized users.

A block 230d may be assigned a value of 240, such as a block number that will be transferred to one or more nodes 210 that perform part or all of the operation. The value 240 may be used to identify the location of block 230d in the blockchain ledger. Also, if the data D0, D1, D2, D3 recorded in a block 230d comprises transactions, a transaction may assign a transaction number TF0, TF1, TF2, TF3 which may be transferred to one or more nodes 210 that perform the operation on the block 230d in which the transaction is recorded. The transaction number may be used to identify the location of the transaction in the blockchain ledger. For example, the transaction number and the blockchain number may be used to identify a location of a transaction in the blockchain ledger.

An operation may be performed to add a new block 230d (e.g., new digital asset, new transaction, etc.) to the blockchain 220, and thus, the nodes 210 may be configured to communicate the new block 230d to the network 200. The nodes 210 may express their acceptance of the new block 230d to the blockchain 220 by working off the block 230d when performing the operation to add a subsequent block to blockchain 220. If more than one version of blockchain 220 exists, node 210 may attempt to work off the longest blockchain 220. The longest blockchain 220 may be determined by an algorithm for scoring the blockchain 220. For example, blockchain 220 may be assigned a score based on the computational work required to create blockchain 220. A node 210 may communicate the longest blockchain 220 that node 210 has observed to network 200, such as with a gossip protocol.

Network 200 may have self-correcting mechanisms, such as to address discrepancies between nodes 210 in network 200. For example, if there is a fork in blockchain 220, a node 210 working off one branch of blockchain 220 may switch to a second branch of blockchain 220, if the second branch becomes longer than the first branch. For example, if node 210 does not receive block 230b, node 210 may request block 230b when node 210 receives the next block 230c and determines that node 210 did not receive the previous block 230b.

One or more nodes 210 in the network 200 may not participate in building the blockchain 220. The operations that node 210 in network 200 may perform relating to the blockchain may not be limited to building blockchain 220. As an example, one or more nodes 210 may monitor the blockchain 220 for particular transactions. For example, node 210 may monitor blockchain 220 for transactions that comprise an identifier associated with a party.

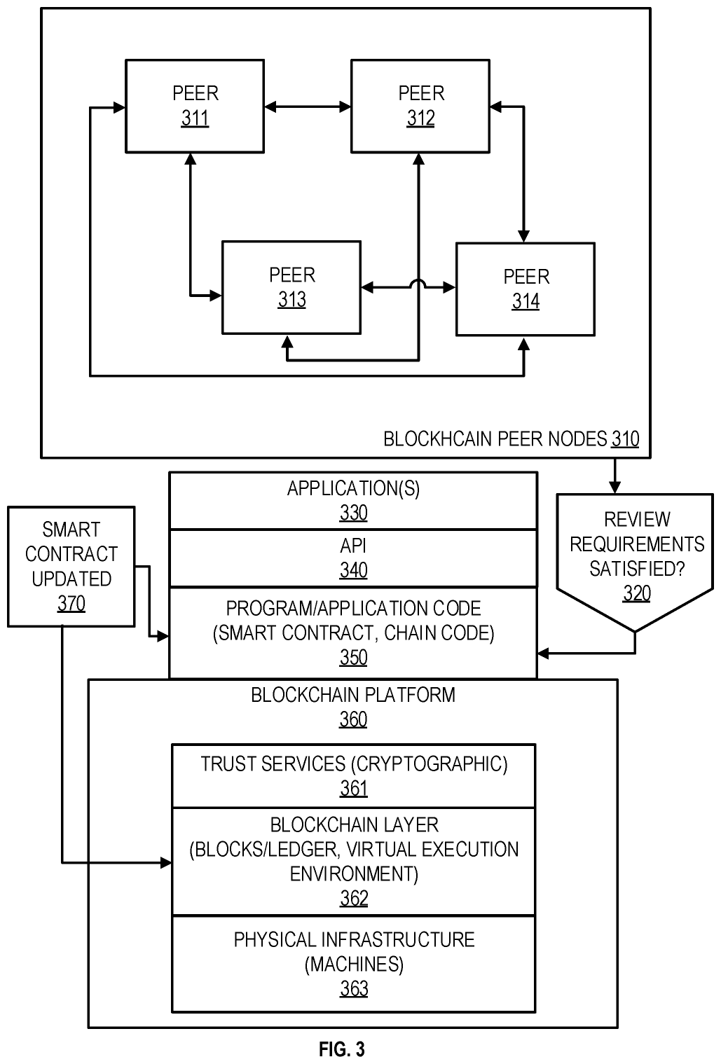

FIG. 3 shows an example blockchain system 300. The blockchain system 300 may comprise a group of blockchain nodes 310 of assigned peers, or peer nodes, 311-314, wherein each peer node 311-314 may participate in the blockchain transaction (e.g., smart contract) validation process (e.g., peer reviews). Each peer node may comprise one or more of a linguistics peer node, a data analytics peer node, a library sciences peer node, etc. In an example, each peer node 311-314 may initiate new transactions and seek to write to the blockchain immutable ledger 364, a copy of which may be stored on the physical infrastructure 366. For example, each peer node 311-314 may initiate transactions, or peer reviews associated with a smart contract, according to each peer node's 311-314 respective background. For example, the linguistics peer node may perform one or more peer reviews according to one or more linguistics criteria, the data analytics peer node may perform one or more peer reviews according to one or more data analytics criteria, and the library sciences peer node may perform one or more peer reviews according to one or more library sciences criteria. As an example, the blockchain configuration may comprise one or more applications 330 linked to APIs 340 to access and execute stored program/application code (e.g., smart contracts) 350. For example, smart contracts 350 may be created based on the digital asset (e.g., research study project) that may require one or more peer reviews. The program/application code (e.g., smart contracts) 350 may be deployed as a transaction and installed, via appending to the distributed blockchain ledger 362, on all blockchain peer nodes 311-314.

The blockchain platform 360 may comprise various layers of blockchain data, services (e.g., cryptographic trust services, virtual execution environment), and physical computer infrastructure that may be necessary to receive and store new transactions and provide access to auditors that may seek to access data entries. The blockchain layer 364 may comprise an interface that may provide access to the virtual execution environment necessary to process the program code and engage the physical infrastructure 366. Cryptographic trust services 361 may be used to verify transactions and keep information private (e.g., encrypted). As a result, smart contract changes which are proposed and/or approved (e.g., via consensus among peers) may be created and updated on the blockchain to accurately update a status of a transaction.

The blockchain system 300 may process and execute program/application code 350 via the interfaces of, and the services provided by, the blockchain platform 360. The code may control blockchain assets. For example, the blockchain program/application code can be implemented to cause data to be stored and transfered, and may be executed by the blockchain in the form of a smart contract, which includes chain code with conditions or other code elements subject to its execution. For example, the smart contracts 350 may be configured to execute reminders, updates, and/or other notifications subject to changes, updates, etc. For example, the smart contracts 350 may include data indicative of rules associated with index data requirements and usage. For example, the index may be defined by terms in the smart contract 350. The policies and updates 370, once decided by the peers (e.g., peer nodes 311-314) via review requirements 320, may be updated into the smart contracts 370 accordingly.

For example, when a blockchain transaction is processed and validated, the blockchain index may be created. The blockchain index may be created based on input data used to execute the transaction, data that was already maintained by the smart contract, and/or data obtained after executing the transaction. A developer of the smart contract may specify which portions of the input data may be used to generate an index key. The index key may comprise a unique identifier used to lookup inside the index table to find which blocks can contain a specific value. For example, index keys may be generated when a transaction is sent to the blockchain network, such as when a request is received for the execution of the smart contract. In an example, the input data may comprise an identifier associated with a peer (e.g., peer node 311-314). Once the smart contract is initiated, the creation of the index key for such transaction(s) may provide various operations. For example, the transaction may be processed, and the smart contract may be executed using input data received from a user for that transaction. Before and/or after the transaction is processed, data may be collected according to the index specification (e.g., peer identifier provided as input to the transaction). The index key may be generated by generating a hash function with the data collected (e.g., peer identifier) and the transaction may be subsequently processed. The transaction is committed into the ledger and the transaction data may include an index key, since the state of the smart contract may be maintained in a persistent media for rapid access. A similar technique may be used to maintain the index keys with the corresponding entries for a rapid look-up operation performed subsequently. The index creation is an extra operation that enables the rapid finding of the blocks, where transactions regarding certain data (e.g., peer identifier) were stored.

The blockchain index may be incrementally generated/updated based on a blockchain transaction. For example, each index key may be generated by applying a composition of functions to the data used to process the transaction or the data included in the transaction itself. The entries for each index key may identify a subset of the entire ledger. Additionally, declarative language may be used to specify one or more functions that may be applied to generate the index key. The language may contain but is not limited to ranging or masking the available data when the transaction is being processed. One or more functions (e.g., cryptographic hash function) may be applied to calculate the index key, wherein the generated index may be stored within the ledger itself. Also, a subset or all index entries may be encrypted with the same or a different cryptographic method and/or secret key.

In an example, the blockchain index may be stored in the blockchain to reflect peer reviews of digital assets (e.g., research study projects). For example, each transaction (e.g., smart contract) may comprise data indicative of peer review requirements (e.g., the required number of peer reviews, required level of peer reviews, etc.) associated with each digital asset (e.g., research study project). For example, a review process may comprise one or more of a required number of reviews associated with one or more peer nodes 311-314 or one or more required reviews associated with one or more peer nodes 311-314 associated with one or more characteristics. One or more characteristics may comprise one or more of an academic level of a peer node 311-314 or a background of a peer node 311-314. For example, the review process may comprise one or more levels of review of the digital asset, wherein each level of the one or more levels of review may be associated with one or more parameters. The one or more parameters may comprise one or more of a required number of reviews by one or more peer nodes 311-314 of one or more backgrounds or a review by a required peer node 311-314. For example, each peer node 311-314 may initiate transactions, or peer reviews associated with a contract, according to each peer node's 311-314 respective background. In an example, the linguistics peer node may perform one or more peer reviews according to one or more linguistics criteria, the data analytics peer node may perform one or more peer reviews according to one or more data analytics criteria, and the library sciences peer node may perform one or more peer reviews according to one or more library sciences criteria. As an example, if a transaction associated with a digital asset indicates that a first level of peer reviews requires a review from 5 peers, if 5 peers (e.g., peer nodes 311-314) have reviewed the content, then the blockchain index may be updated to reflect completion of the first level of review. As an example, if a transaction associated with a digital asset indicates that a digital asset requires 10 reviews, then if 10 peers have reviewed the content, the blockchain index may be incremented each time to reflect each peer review. For example, the satisfaction, or completion, of each review requirement may be indicative of a score reflecting the relative validity of the digital asset. The blockchain index may be modified each time in the blockchain to score the digital asset associated with a transaction. As an example, if a transaction associated with a digital asset indicates that a level of review for a digital asset requires at 2 reviews from the linguistics peer node, 3 reviews from the data analytics peer node, and 5 reviews from the library sciences peer node, the blockchain index may be incremented once 2 reviews are received from the linguistics peer node, 3 reviews are received from the data analytics peer node, and 5 reviews are received from the library sciences peer node.

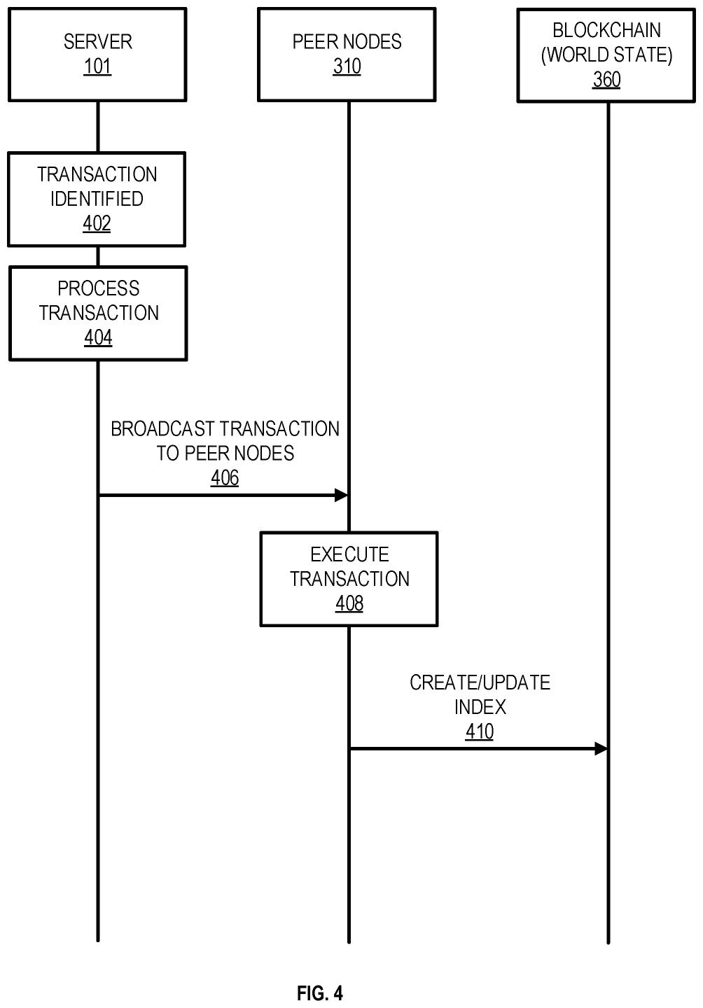

FIG. 4 shows an example peer review process 400 for updating a smart contract according to a blockchain index update. At 402, server 101 may identify/determine a transaction (e.g., smart contract) associated with a digital asset (e.g., research study project). At 404, server 101 may process the transaction to determine the review process associated with the digital asset and the peer nodes 310 associated with the review process associated with the digital asset. At 406, server 101 may broadcast the transaction to the peer node 310 associated with the determined review process. At 408, the peer nodes 310 may execute the transaction, or execute the peer review process, associated with the transaction. For example, the peer review process may comprise one or more of the required number of reviews associated with one or more peer nodes 310 or one or more required reviews associated with one or more peer nodes 310 associated with one or more characteristics. The one or more characteristics may comprise one or more of an academic level of a peer node 310 or a background of a peer node 310. For example, the review process may comprise one or more levels of review of the digital asset, wherein each level of the one or more levels of review may be associated with one or more parameters. The one or more parameters may comprise one or more of a required number of reviews by one or more peer nodes 310 of one or more backgrounds or a review by a required peer node 310. In an example, a linguistics peer node may perform one or more peer reviews according to one or more linguistics criteria, a data analytics peer node may perform one or more peer reviews according to one or more data analytics criteria, and a library sciences peer node may perform one or more peer reviews according to one or more library sciences criteria. At the completion of the transaction or peer review process, at 410, a blockchain index may be created or updated, and stored in the blockchain 360. In an example, an actor/entity (user, system, etc.) sends an invoke transaction to a peer node 310 that is part of the blockchain network. This transaction triggers the execution of the smart contract operation, where a blockchain index specification is generated based on the rules specified in the smart contract and using the parameters received. The resulting specification is stored in the blockchain's world state. For example, after the transaction is completed, the digital asset may be sent to a device associated with a digital library.

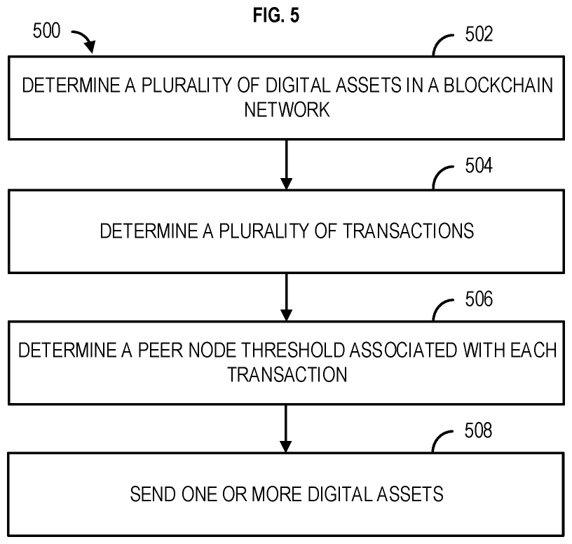

FIG. 5 shows a flowchart of an example method 500 for processing a plurality of transactions associated with a plurality of digital assets. Method 500 may be performed by a device such as a server computing device 101 and/or the blockchain 105. At step 502, a plurality of digital assets in a blockchain network may be determined. For example, the plurality of digital assets may be determined by the device (e.g., server computing device 101, blockchain 105, etc.). Each digital asset of the plurality of digital assets may comprise a research study project. For example, each digital asset may be stored in the blockchain network.

At step 504, a plurality of transactions may be determined based on each digital asset of the plurality of digital assets. For example, the plurality of transactions may be determined by the device (e.g., server computing device 101, blockchain 105, etc.) based on each digital asset. Each transaction of the plurality of transactions may be associated with one or more peer nodes of a plurality of peer nodes in the blockchain network. For example, each transaction may comprise a smart contract, wherein each contract may comprise data indicative of a review process associated with a digital asset. For example, the review process may comprise one or more of a required number of reviews associated with one or more peer nodes or one or more required reviews associated with one or more peer nodes associated with one or more characteristics. The one or more characteristics may comprise one or more of an academic level of a peer node or a background of a peer node. For example, the review process may comprise one or more levels of review of the digital asset, wherein each level of the one or more levels of review may be associated with one or more parameters. The one or more parameters may comprise one or more of a required number of reviews by one or more peer nodes of one or more backgrounds or a review by a required peer node. In an example, a linguistics peer node may perform one or more peer reviews according to one or more linguistics criteria, a data analytics peer node may perform one or more peer reviews according to one or more data analytics criteria, and a library sciences peer node may perform one or more peer reviews according to one or more library sciences criteria. Each transaction may be stored in a blockchain ledger of the blockchain network according to a transaction number and a block number identifying a location of the transaction in the blockchain ledger.

At step 506, a peer node threshold associated with each transaction may be determined based on the one or more peer nodes associated with each transaction. For example, the peer node threshold may be determined by the device (e.g., server computing device 101, blockchain 105, etc.) based on the one or more peer nodes associated with each transaction. The peer node threshold may be based on the review process associated with each transaction. As an example, a transaction associated with a digital asset may indicate that a first level of peer review requires a review from 5 peers. As an example, a transaction associated with a digital asset may indicate that a digital asset requires a total of 10 reviews from one or more academic professors. As an example, a transaction associated with a digital asset may indicate that a level of review for a digital asset requires at 2 reviews from the linguistics peer node, 3 reviews from the data analytics peer node, and 5 reviews from the library sciences peer node.

At step 508, one or more digital assets may be sent based on one or more transactions of the plurality of transactions satisfying the peer node threshold. For example, one or more digital assets may be sent by the device (e.g., server computing device 101, blockchain 105, etc.) based on one or more transactions satisfying the peer node threshold. For example, one or more digital assets may be sent to a device associated with a digital library. For example, a plurality of blockchain indexes may be generated based on the review process associated with each digital asset. Each blockchain index of the plurality of blockchain indexes may be associated with each digital asset. Each blockchain index may be updated based on one or more reviews by one or more peer nodes associated with each transaction. As an example, if a transaction associated with a digital asset indicates that a first level of peer review requires a review from 5 peers, if 5 peers have reviewed the content, then the blockchain index may be updated to reflect the completion of the first level of review. As an example, if a transaction associated with a digital asset indicates that a digital asset requires 10 reviews, if 10 peers have reviewed the content, the blockchain index may be incremented each time to reflect each peer review. As an example, if a transaction associated with a digital asset indicates that a level of review for a digital asset requires at 2 reviews from the linguistics peer node, 3 reviews from the data analytics peer node, and 5 reviews from the library sciences peer node, the blockchain index may be incremented once 2 reviews are received from the linguistics peer node, 3 reviews are received from the data analytics peer node, and 5 reviews are received from the library sciences peer node.

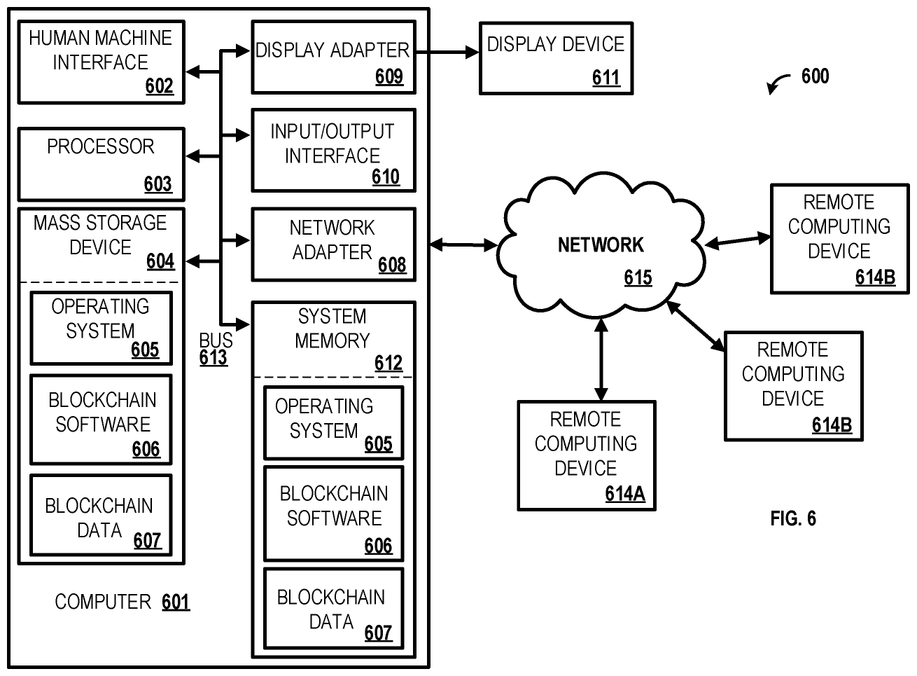

The methods and systems may be implemented on a computer 601 as illustrated in FIG. 6 and described below. By way of example, the server computing device 101, the admin device 102, and/or the peer nodes 103 of FIG. 1 can be a computer 601 as illustrated in FIG. 6. Similarly, the methods and systems disclosed can utilize one or more computers to perform one or more functions in one or more locations. FIG. 6 is a block diagram illustrating an example operating environment 600 for performing the disclosed methods. This example operating environment 600 is only an example of an operating environment and is not intended to suggest any limitation as to the scope of use or functionality of operating environment architecture. Neither should the operating environment 600 be interpreted as having any dependency or requirement relating to any one or combination of components illustrated in the example operating environment 600.

The present methods and systems can be operational with numerous other general-purpose or special-purpose computing system environments or configurations. Examples of well-known computing systems, environments, and/or configurations that can be suitable for use with the systems and methods comprise, but are not limited to, personal computers, server computers, laptop devices, and multiprocessor systems. Additional examples comprise set-top boxes, programmable consumer electronics, network PCs, minicomputers, mainframe computers, distributed computing environments that comprise any of the above systems or devices, and the like.

The processing of the disclosed methods and systems can be performed by software components. The disclosed systems and methods can be described in the general context of computer-executable instructions, such as program modules, being executed by one or more computers or other devices. Generally, program modules comprise computer code, routines, programs, objects, components, data structures, and/or the like that perform particular tasks or implement particular abstract data types. The disclosed methods can also be practiced in grid-based and distributed computing environments where tasks are performed by remote processing devices that are linked through a communications network. In a distributed computing environment, program modules can be located in local and/or remote computer storage media such as memory storage devices.

Further, one skilled in the art will appreciate that the systems and methods disclosed herein can be implemented via a general-purpose computing device in the form of a computer 601. The computer 601 can comprise one or more components, such as one or more processors 603, a system memory 612, and a bus 613 that couples various components of the computer 601 comprising the one or more processors 603 to the system memory 612. The system can utilize parallel computing.

The bus 613 can comprise one or more of several possible types of bus structures, such as a memory bus, memory controller, a peripheral bus, an accelerated graphics port, or a local bus using any of a variety of bus architectures. By way of example, such architectures can comprise an Industry Standard Architecture (ISA) bus, a Micro Channel Architecture (MCA) bus, an Enhanced ISA (EISA) bus, a Video Electronics Standards Association (VESA) local bus, an Accelerated Graphics Port (AGP) bus, and a Peripheral Component Interconnects (PCI), a PCI-Express bus, a Personal Computer Memory Card Industry Association (PCMCIA), Universal Serial Bus (USB) and the like. The bus 613, and all buses specified in this description can also be implemented over a wired or wireless network connection and one or more of the components of the computer 601, such as the one or more processors 603, a mass storage device 604, an operating system 605, blockchain software 606, blockchain data 607, a network adapter 608, the system memory 612, an Input/Output Interface 610, a display adapter 609, a display device 611, and a human-machine interface 602, can be contained within one or more remote computing devices 614A-614C at physically separate locations, connected through buses of this form, in effect implementing a fully distributed system.

The computer 601 typically comprises a variety of computer-readable media. Examples of readable media can be any available media that is accessible by the computer 601 and comprises, for example, and not meant to be limiting, both volatile and non-volatile media, removable and non-removable media. System memory 612 can comprise computer-readable media in the form of volatile memory, such as random-access memory (RAM), and/or non-volatile memory, such as read-only memory (ROM). The system memory 612 typically can comprise data such as the blockchain data 607 and/or program modules such as the operating system 605 and the blockchain software 606 that are accessible to and/or are operated on by one or more processors 603.

In another aspect, the computer 601 can also comprise other removable/non-removable, volatile/non-volatile computer storage media. The mass storage device 604 can provide non-volatile storage of computer code, computer readable instructions, data structures, program modules, and other data for computer 601. For example, the mass storage device 604 can be a hard disk, a removable magnetic disk, a removable optical disk, magnetic cassettes or other magnetic storage devices, flash memory cards, CD-ROM, digital versatile disks (DVD), or other optical storage, random access memories (RAM), read-only memories (ROM), electrically erasable programmable read-only memory (EEPROM), and the like.

Optionally, any number of program modules can be stored on the mass storage device 604, such as, by way of example, the operating system 605 and the blockchain software 606. One or more of the operating system 605 and the blockchain software 606 (or some combination thereof) can comprise elements of the programming and the blockchain software 606. Blockchain data 607 can also be stored on the mass storage device 604. Blockchain data 607 can be stored in any of one or more databases known in the art. Examples of such databases comprise, DB2®, Microsoft® Access, Microsoft® SQL Server, Oracle®, mySQL, PostgreSQL, and the like. The databases can be centralized or distributed across multiple locations within the network 615.

In an example, the user can enter commands and information into the computer 601 via an input device (not shown). Examples of such input devices comprise, but are not limited to, a keyboard, pointing device (e.g., a computer mouse, remote control), a microphone, a joystick, a scanner, tactile input devices such as gloves, and other body coverings, motion sensor, and the like These and other input devices can be connected to the one or more processors 603 via the human-machine interface 602 that is coupled to the bus 613, but can be connected by other interface and bus structures, such as a parallel port, game port, an IEEE 1394 Port (also known as a Firewire port), a serial port, a network adapter 608, and/or a universal serial bus (USB).

In an example, the display device 611 can also be connected to bus 613 via an interface, such as the display adapter 609. It is contemplated that the computer 601 can have more than one display adapter 609 and the computer 601 can have more than one display device 611. For example, the display device 611 can be a monitor, an LCD (Liquid Crystal Display), a light-emitting diode (LED) display, a television, a smart lens, smart glass, and/or a projector. In addition to the display device 611, other output peripheral devices can comprise components such as speakers (not shown) and a printer (not shown) which can be connected to the computer 601 via an Input/Output Interface 610. Any step and/or result of the methods can be output in any form to an output device. Such output can be any form of visual representation, comprising, but not limited to, textual, graphical, animation, audio, tactile, and the like. The display device 611 and the computer 601 can be part of one device, or separate devices.

Computer 601 can operate in a networked environment using logical connections to one or more remote computing devices 614A-614C. By way of example, a remote computing device 614A-614C can be a personal computer, computing station (e.g., workstation), portable computer (e.g., laptop, mobile phone, tablet device), smart device (e.g., smartphone, smartwatch, activity tracker, smart apparel, smart accessory), security and/or monitoring device, a server, a router, a network computer, a peer device, edge device or another common network node, and so on. Logical connections between computer 601 and a remote computing device 614A-614C can be made via a network 615, such as a local area network (LAN) and/or a general wide area network (WAN). Such network connections can be through the network adapter 608. The network adapter 608 can be implemented in both wired and wireless environments. Such networking environments are conventional and commonplace in dwellings, offices, enterprise-wide computer networks, intranets, and the Internet.

For purposes of illustration, application programs and other executable program components such as the operating system 605 are illustrated herein as discrete blocks, although it is recognized that such programs and components can reside at various times in different storage components of the computing device 601 and are executed by the one or more processors 603 of the computer 601. An implementation of the blockchain software 606 can be stored on or transmitted across some form of computer-readable media. Any of the disclosed methods can be performed by computer-readable instructions embodied in computer-readable media. Computer-readable media can be any available media that can be accessed by a computer. By way of example and not meant to be limiting, computer-readable media can comprise “computer storage media” and “communications media.” “Computer storage media” can comprise volatile and non-volatile, removable, and non-removable media implemented in any methods or technology for storage of information such as computer readable instructions, data structures, program modules, or other data. Example computer storage media can comprise RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information, and which can be accessed by a computer.

The methods and systems can employ artificial intelligence (AI) techniques such as machine learning and iterative learning. Examples of such techniques comprise, but are not limited to, expert systems, case-based reasoning, Bayesian networks, behavior-based AI, neural networks, fuzzy systems, evolutionary computation (e.g. genetic algorithms), swarm intelligence (e.g. ant algorithms), and hybrid intelligent systems (e.g. Expert inference rules generated through a neural network or production rules from statistical learning).

While the methods and systems have been described in connection with preferred embodiments and specific examples, it is not intended that the scope be limited to the particular embodiments set forth, as the embodiments herein are intended in all respects to be illustrative rather than restrictive.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that an order be inferred, in any respect. This holds for any possible non-express basis for interpretation, such as: matters of logic with respect to arrangement of steps or operational flow; plain meaning derived from grammatical organization or punctuation; the number or type of embodiments described in the specification.

It will be apparent to those skilled in the art that various modifications and variations may be made without departing from the scope or spirit. Other configurations will be apparent to those skilled in the art from consideration of the specification and practice described herein. It is intended that the specification and described configurations be considered as examples only, with a true scope and spirit being indicated by the following claims.

1. A method comprising:
determining, by a computing device, a plurality of digital assets in a blockchain network;
determining, based on each digital asset of the plurality of digital assets, a plurality of transactions, wherein each transaction of the plurality of transactions is associated with one or more peer nodes of a plurality of peer nodes in the blockchain network;
determining, based on the one or more peer nodes associated with each transaction, a peer node threshold associated with each transaction; and
sending, based on one or more transactions of the plurality of transactions satisfying the peer node threshold, one or more digital assets.

2. The method of claim 1, wherein each digital asset of the plurality of digital assets comprises a research study project.

3. The method of claim 1, wherein each transaction is stored in a blockchain ledger of the blockchain network according to a transaction number and a block number identifying a location of the transaction in the blockchain ledger.

4. The method of claim 1, wherein each transaction comprises a smart contract comprising data indicative of one or more of a review process, a collaboration process, a data analytics review process, or a linguistics review process associated with a digital asset.

5. The method of claim 4, wherein determining, based on the one or more peer nodes associated with each transaction, the peer node threshold associated with each transaction comprises determining, based on the review process associated with each transaction, the peer node threshold associated with each transaction.

6. The method of claim 4, wherein the review process comprise one or more of a required number of reviews associated with the one or more peer nodes, one or more required reviews associated with the one or more peer nodes associated with one or more characteristics, or one or more levels of review of the digital asset.

7. The method of claim 6, wherein the one or more characteristics comprise one or more of an academic level of a peer node or a background of a peer node.

8. The method of claim 6, wherein the one or more levels of review are associated with one or more parameters, wherein the one or more parameters comprise one or more of a required number of reviews by one or more peer nodes of one or more backgrounds or a review by a required peer node.

9. The method of claim 4, further comprising generating, based on the review process associated with each digital asset, a plurality of blockchain indexes, wherein each blockchain index of the plurality of blockchain indexes is updated based on one or more reviews by the one or more peer nodes associated with each transaction.

10. The method of claim 1, further comprising sending the one or more digital assets to a device, wherein the device is associated with one or more digital libraries.

11. An apparatus comprising:
one or more processors; and
a memory storing processor-executable instructions that, when executed by the one or more processors, cause the apparatus to:
determine, by a computing device, a plurality of digital assets in a blockchain network;
determine, based on each digital asset of the plurality of digital assets, a plurality of transactions, wherein each transaction of the plurality of transactions is associated with one or more peer nodes of a plurality of peer nodes in the blockchain network;
determine, based on the one or more peer nodes associated with each transaction, a peer node threshold associated with each transaction; and
send, based on one or more transactions of the plurality of transactions satisfying the peer node threshold, one or more digital assets.

12. The apparatus of claim 11, wherein each digital asset of the plurality of digital assets comprises a research study project.

13. The apparatus of claim 11, wherein each transaction is stored in a blockchain ledger of the blockchain network according to a transaction number and a block number identifying a location of the transaction in the blockchain ledger.

14. The apparatus of claim 11, wherein each transaction comprises a smart contract comprising data indicative of one or more of a review process, a collaboration process, a data analytics review process, or a linguistics review process associated with a digital asset.

15. The apparatus of claim 14, wherein the processor-executable instructions, when executed by the one or more processors, cause the apparatus to determine, based on the one or more peer nodes associated with each transaction, the peer node threshold associated with each transaction further cause the apparatus to determine, based on the review process associated with each transaction, the peer node threshold associated with each transaction.

16. The apparatus of claim 14, wherein the review process comprises one or more of a required number of reviews associated with the one or more peer nodes, one or more required reviews associated with the one or more peer nodes associated with one or more characteristics, or one or more levels of review of the digital asset.

17. The apparatus of claim 16, wherein the one or more characteristics comprise one or more of an academic level of a peer node or a background of a peer node.

18. The apparatus of claim 16, wherein the one or more levels of review are associated with one or more parameters, wherein the one or more parameters comprise one or more of a required number of reviews by one or more peer nodes of one or more backgrounds or a review by a required peer node.

19. The apparatus of claim 14, wherein the processor-executable instructions that, when executed by the one or more processors, further cause the apparatus to generate, based on the review process associated with each digital asset, a plurality of blockchain indexes, wherein each blockchain index of the plurality of blockchain indexes is updated based on one or more reviews by the one or more peer nodes associated with each transaction.

20. The apparatus of claim 11, wherein the processor-executable instructions that, when executed by the one or more processors, further cause the apparatus to send the one or more digital assets to a device, wherein the device is associated with one or more digital libraries.
